(19) United States
(12) Patent Application Publication
(10) Pub. No.: US 2013/0154552 A1
(43) Pub. Date: Jun. 20, 2013

(54) Energy Box Having an Inductive Charger, and a Method for Charging an Energy Box

(71) Applicant: Bernhard SIESSEGGER, Danvers, MA (US)

(72) Inventor: Bernhard SIESSEGGER, Danvers, MA (US)

(73) Assignee: OSRAM AG, Munich (DE)

(21) Appl. No.: 13/365,034

(22) Filed: Feb. 2, 2012

(30) Foreign Application Priority Data
Feb. 2, 2011 (DE) 10 2011 003 516.8

(51) Int. Cl. H02J 7/00

(52) U.S. Cl. CPC H02J 7/0042; H02J 7/0052
USPC 320/108; 320/137

(57) ABSTRACT

An energy box comprising a rechargeable battery, charging electronics having an information transmitter which is connected to the rechargeable battery, an inductive charging device, which is connected to the charging electronics, a controller having an information memory, which controller controls the charging electronics, at least one sensor for detection of useful data, which sensor is connected to the controller, at least one semiconductor light source, which is used both for indication of data and for transmission of useful data, the useful data which is stored in the controller being transmitted optically via the at least one semiconductor light source during the charging process.

### RELATED APPLICATIONS

This application claims the priority of German application no. 10 2011 003 516.8 filed Feb. 2, 2011, the entire content of which is hereby incorporated by reference.

### FIELD OF THE INVENTION

The invention relates to an energy box which can insure a basic supply of electrical power, and to a method for charging such an energy box. More particularly, the invention relates to an energy box having an inductive charger

### BACKGROUND OF THE INVENTION

Mobile energy boxes are known which can ensure a basic supply of electrical power for the purpose of illumination or for operation of mobile appliances etc., in areas without a power supply, for example in mountain huts, or in thinly populated areas, as well as in poverty-stricken areas of large cities. It is likewise known that battery-operated systems can be charged inductively.

WO 2007/090168 discloses an inductive charging system for portable appliances, in which the coil of the receiver is also used to transmit data to the charging station.

WO 2008/038203 discloses an inductive charging system, in which overvoltage or overcurrent information is transmitted from the rechargeable battery of the charger to the charging system, by varying the impedance of the load circuit.

WO 2009/059638 discloses an energy box which can be charged with solar energy anywhere, and is also used as a light.

Particularly in poverty-stricken areas, the people often cannot afford appliances such as these, for which reason they may be rented via an exchange system there. In this case, the energy boxes are rented out fully charged, and are returned empty, and a combined fee is charged, which includes a rental fee, a usage fee and the cost for the energy consumed. One problem that arises in this case is that misuse or incorrect use or storage of the energy boxes actually cannot be identified, and this can lead to the rechargeable batteries having a shorter life, and to the rental business being uneconomic.

Attempts have been made to overcome the problem of particularly rapid aging by means of high-quality rechargeable batteries and by replacing them frequently, but this correspondingly reduced the economic viability. Lead-acid rechargeable batteries are primarily used for energy boxes such as these, for cost reasons.

The life of the energy boxes, in particular that of the rechargeable batteries, is critically dependent on how the user handles the energy boxes. In particular, the following states are particularly disadvantageous:
storage in the discharged state
This state is particularly disadvantageous because,
1. storage in particular of a lead-acid rechargeable battery in the discharged state has a negative influence on the rechargeable-battery life, and
2. the appliance is “dead capital”, because it cannot produce a financial return during rental use;
high temperatures, since they reduce the rechargeable-battery life;
moisture/water, since they cause the electronics to malfunction, and corrosion;
impact and shock load;
A load such as this has a less negative effect on the rechargeable battery than, in fact, on the mechanism/the housing, since the rechargeable battery is heavy, and the forces which occur are in consequence very high.

At the moment, most of these appliances are charged using cables. Contactless charging would have the advantage that this would overcome contact problems, would allow the housing to be sealed considerably more easily and, furthermore, chelation attempts would be more complex, and could be identified more easily. These problems could be solved easily and at low cost by a welded plastic housing.

On return, no useful data is evaluated, since the known energy boxes do not record any user data, or record only a small amount of user data.

### SUMMARY OF THE INVENTION

One object of the invention is to provide an improved energy box which no longer has the above-mentioned disadvantages.

One aspect of the invention relates to an energy box which also has rechargeable batteries, and which may also have a light or has connections for operation of a light, with the energy box
being supplied with energy via an inductive charging apparatus,
having charging electronics which
contain a data memory, and
the charging electronics interchange this data with a charging apparatus.

The data is interchanged while charging. In this case, information from the charger is transmitted to the energy store by modulation of the inductive field, which is primarily used for charging. The energy box has optical means, which it uses to transmit information to the charger, and which have themselves an optical receiver for this purpose.

Based on this idea, an energy box is proposed which stores useful data and transmits this useful data to the charger during charging, thus allowing optimized charging as a function of the useful data. This optimized charging method makes it possible to increase the life of the rechargeable batteries, and therefore to improve the financial viability of the rental business, per se. In addition, the rental fee can be increased for incorrect use, since this is directly available when the energy box is returned, because the useful data is also stored.

One embodiment of an energy box according to the invention comprises:
a rechargeable battery,
charging electronics having an information transmitter which is connected to the rechargeable battery,
an inductive charging device, which is connected to the charging electronics,
a controller having an information memory, which controller controls the charging electronics,
at least one sensor for detection of useful data, which sensor is connected to the controller,
at least one semiconductor light source, which is used both for indication of data and for transmission of useful data,
the useful data which is stored in the controller being transmitted optically via the at least one semiconductor light source during the charging process.

The energy box can preferably transmit data via the inductive charging device.

Particularly preferably, the energy box can transmit data inductively via the charging device and optically via the semiconductor light sources. In this case, data is preferably transmitted inductively from a charger to the energy box, and data is transmitted optically from the energy box to the charger.

The charging electronics are preferably operated differently depending on the useful data, in order to allow the charging method for the rechargeable battery to be matched to the stored useful data. For example, a rechargeable battery which has been deep-discharged because the energy box has been stored for a long time in the empty state, can be charged as normal with a higher current, in order to reform it. A rechargeable battery in an energy box which has been handled correctly can be charged very conservatively, in order to preserve the life.

Another aspect of the invention relates to a method for charging an energy box comprising the steps of:
authorization of the energy box and of a charger which charges the energy box,
transmission of useful data, which is stored in the energy box, to the charger,
setting of charging parameters on the basis of the transmitted useful data.

This method makes it possible to achieve an optimum charging quality for the rechargeable battery which is installed in the energy box.

Preferably, the charging parameters and/or other data are/is transmitted from the charger to the energy box. This allows the major charging intelligence to reside in the charger, making the energy box itself simple and cost-effective.

In this case, the data may be transmitted optically. However, the data may also be transmitted inductively. In one preferred embodiment, the data is transmitted optically and inductively. Preferably, the data and/or the charging parameters is/are transmitted inductively from the charger to the energy box. Preferably, the useful data is transmitted optically from the energy box, particularly preferably by means of one or more light-emitting diodes which are provided in the energy box for indication or illumination purposes.

This allows the energy box to be designed simply and reliably, and the amount of data to be transmitted is matched to the transmission method.

Further advantageous developments and refinements of the energy box according to the invention result from the further dependent claims and from the following description.

### BRIEF DESCRIPTION OF THE DRAWINGS

Further advantages, features and details of the invention will become evident from the following description of the exemplary embodiments and from the drawings, in which elements which are the same or have the same function are provided with identical reference symbols. In this case:

FIG. 1 shows an example of a weighting function with which the temperature could be weighted,

FIG. 2 shows the program counter in the microcontroller, with a counter/memory functionality implemented,

FIG. 3 shows a block diagram of the energy box according to an embodiment of the invention and of a charger, which have implemented bidirectional communication,

FIG. 4 shows one exemplary embodiment of a possible energy box with the corresponding charger, in which it is located,

FIG. 5 shows an energy box with an integrated hand light and an optical communication interface located in the charger,

FIG. 6 shows an energy box which communicates with the charger optically and inductively, with data being transmitted optically from the energy box by lighting means and photo receivers, and the data being transmitted inductively from the charger via the inductive charging device to the energy box.

### DETAILED DESCRIPTION OF THE DRAWINGS

The “history of use”, and/or variables derived therefrom (such as the remaining discount) are/is recorded in the energy box by means of a microcontroller, thus resulting in a microcontroller-based “intelligent” energy box. Various technical measurement data and time intervals are also recorded in this case.

This makes it possible to ensure that the customers handle the energy box better, since they have to pay greater rental fees if handled incorrectly. By way of example, the rental model may appear as follows: during the rental process for the energy box, the person renting it is given an explanation of how to handle the energy box. The usage conditions could be: Do not subject to direct solar radiation or heat, do not place in water, do not subject to any increased mechanical loading, after discharging, return to the replacement station within the maximum empty storage period of, for example, 3 days, etc.

If the person renting the energy box returns it to the replacement station or to the rental agency within the maximum empty storage duration and if he has also handled the energy box “conservatively”, that is to say has followed the rest of the usage rules mentioned above, he will receive a discount for the next charging process: for example, he pays only [symbol] 0.60 for the next charging process, and receives the deposit plus [symbol] 0.10 back.

The counting of the empty storage duration starts from the time from which the energy box has indicated the “rechargeable battery (virtually) empty” state to the user, and made him aware of this, for example by means of a blinking light-emitting diode.

If the person renting the energy box has only partially complied with the conditions, the discount is reduced depending on the “severity and duration” of the infringement of the usage conditions. For example, going beyond the return date by a small amount, for example by three days, will still result in a discount of [symbol] 0.08 while, in contrast, an accumulated storage duration of more than 12 hours at >65° C. will lead to complete loss of the discount.

If the energy box is extremely badly “mishandled” or mechanical damage (which can be seen from the outside) is at all present, the deposit will no longer be completely refunded, but will be reduced by an amount corresponding to the recorded useful data. The energy box is then removed from the normal rental business, for repair. The latter likewise occurs when, on the basis of the recorded data, the rechargeable-battery capacity has fallen below a certain threshold, or a certain number of charging/discharge cycles has been reached.

The recording of the measurement data detected in the energy box to form a “history of use” is carried out in the EEPROM in the microcontroller. The use of a non-volatile and rewritable memory such as an EEPROM or flash memory has the advantage that, in the event of complete discharging and therefore in an interruption in the voltage supplied to the microcontroller for a time, the data gathered before the interruption is not lost. The memory may be integrated in the microcontroller or may be in the form of an external memory, which can be written to and read from the microcontroller.

If the microcontroller is not required for other functions (for example communication with the charger, etc.) then it automatically switches itself to a so-called sleep mode, in which the microcontroller consumes particularly little power. Only a timer or the clock in the microcontroller continues to run. When the timer times out, for example after one minute, or a specific clock time is reached, the microcontroller wakes itself up and, for example, measures the temperature, measures the moisture etc. every third time it is woken up and, if the state of charge is “empty”, furthermore increments the counter which measures the time until the energy box is returned again.

The temperature is advantageously measured by a temperature sensor which is contained directly in the microcontroller, since this variant can be implemented particularly cost-effectively and easily and/or by a temperature sensor which is fitted directly to the rechargeable battery. The latter is more complex but makes it possible to evaluate the rechargeable-battery temperature both for the discharging and for the charging process in order, for example, to prevent overheating of the rechargeable battery, as is already prior art, at least for the charging of rechargeable batteries. Depending on the arrangement of the microcontroller in the housing, the temperature sensor contained in the microcontroller will in fact record the housing or ambient temperature as the temperature of the rechargeable battery, and this sensor may therefore even be more suitable for the application under consideration, because the customer can directly influence only the ambient temperature and can also in consequence be made “responsible” only for this. However, one exception is energy boxes in which the user has the capability to operate external loads. In this case, the rechargeable-battery temperature would be used, with the user being advised to provide good ventilation for the appliance.

High acceleration forces are detected by an acceleration sensor. In particular, a G-sensor or acceleration sensor based on MEMS technology (micro-electro-mechanical systems) is possible, as used in driver assistance systems in motor vehicles, in cameras or other handheld devices.

If the energy box has a sufficiently large amount of memory space, then all the measured values are recorded chronologically in the energy box, and are transmitted to the charger during the next charging process. The charger uses the data to calculate the discount.

The energy box has the capability to indicate to the user a rough estimate of the discount to be expected (by a display or in this application more probably by blinking characters, for example each blink means a discount of one cent, and the user need only count the number of blinking pulses). For this purpose, a simplified computation model is stored in the microcontroller, and determines the estimated discount from the recorded measures values. Alternatively, the counter memory, which will be explained further below, is used for this purpose, and this is updated for every measured value, in parallel with the detection of the measured values by the microcontroller.

The energy box advantageously has an internal clock, such that the clock time is likewise recorded. Alternatively, the energy box has a unique identification (in order to make it possible to distinguish it from other physically identical energy boxes on the charger), and the clock time since the energy box was completely charged and the internal data record began is stored in a database in the charger.

Further measured values are recorded in addition to the measured values mentioned above, by means of which compliance with the usage conditions can be determined. These include, for example, the rechargeable-battery voltage and the rechargeable-battery current drawn. In the case of energy boxes which can at the same time be used as lights, it is possible, for example, to record whether the light is switched on and what type of light is used (in the case of a combination light, for example, comprising a fluorescent lamp providing omnidirectional illumination and an LED emitter which can be used as a flashlight), as well as the dimming position of the lighting means. This can be used to determine an (anonymous) user profile, which can be used for subsequent product optimizations and product developments. Furthermore, the operating hours of the lighting means can be detected, with their replacement being initiated as appropriate.

It is also possible to transmit the data periodically by data radio (for example by means of a GSM module which is operated by the microcontroller), furthermore allowing the energy box to be located, as well as allowing remote maintenance.

The energy box can use the determined user profile (within the last days since the rental of the energy box or else over the last charging/discharge cycles) for learning purposes, and, for example, can signal to the user when the remaining charge is only sufficient for less than, for example, 2 days, based on his user behavior. The user can then better plan when the energy box must be recharged, and when he must take it for charging.

If one wishes to avoid wasting a large amount of memory space in the energy box, for example for cost reasons, the data gathered is compressed. By way of example, only changes in the measured values are noted (time duration since the old value was measured+new measured value). Furthermore, compression involving losses can also be used, for example with the temperature being stored only at 5° C. intervals, even though the temperature is measured, for example, with a resolution of 0.5° C., and, furthermore, with the storage process being carried out only when a certain threshold value is exceeded, below which no reduction in his discount will occur. Furthermore, for example, only changes in the rechargeable-battery current level are noted, while a certain minimum discrepancy occurs from the previous measured value (if the current fluctuates by less than 1% of the maximum current, this is not noted).

In cost-sensitive applications, in all probability only a very small amount of memory space will be available in the energy box. In this case, no chronology can be created and only “infringements” against the usage conditions and their severity are recorded, but not the time of occurrence.

A counter memory is implemented in the memory: The microcontroller detects the measured values periodically. There are two counters (for example a primary and a secondary counter for the temperature, the moisture, in the EEPROM for each measurement variable (or for each “mishandling case”). A weight is determined depending on the present measured value (for example 76° C.) of the measurement variable (for example temperature). The weight reflects the “severity” of the infringement of the usage conditions. Both counters are then incremented by the weight (counting up without an overflow).

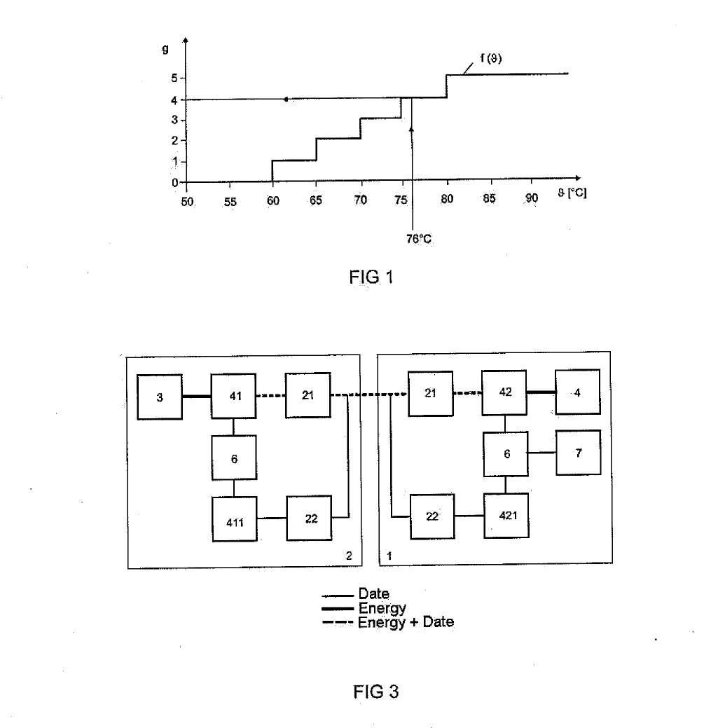

FIG. 1 shows an exemplary weighting function with which the temperature could be weighted. The exemplary measured value of 76° C. would result in a weight of 4, because, for example, 76° C. occurs in the fourth 5° C. step above the maximum permissible temperature of the energy box of 60° C. communicated to the user.

The first counter adds up over the life of the energy box of 60° C. (for example 24 bits in the EEPROM) or of the rechargeable battery, while the second adds up only over the present rental time (for example a counter with a width of only 16 bits). The second counter and the associated memory cells are read when the energy box is returned (in order to be able to tell the customer why he may not be receiving the full discount), and is then reset to zero at the start of the recharging process. During a normal charging process, the first counter is only read, but is not deleted or reset. The data relating to each measurement variable in the second counters makes it possible to produce statistics which initiate automatic maintenance of the appliances and/or also compare rechargeable batteries from different manufacturers in the field with one another (rechargeable-battery benchmark). The second counters may be reset after repair.

The discount on return could be determined by the charger, on the basis of the primary counts. However, advantageously, the discount is likewise reflected in the memory by means of a counter, and the discount is reduced as the infringements increase, that is to say as the primary and secondary counters count up (subtraction without going below zero). This has the advantage that the present discount can likewise be indicated to the user. For example, an indication light-emitting diode on the control panel of the energy box could blink on pressing a “Discount?” button. In the case of an energy box having a built-in light-emitting diode light, the light-emitting diode which represents the primary light source of the energy box could blink a number of times, with this number corresponding to 1 (or 2, 5, . . . ) cent pieces (or whatever currency is also used), which the user would still receive as a discount at that time. In this case, by way of example, only the 5 most significant bits of the discount counter, which has a width of 32 bits, by way of example, are output. During each charging process, the discount counter is set to the value which the user can obtain as the maximum discount (for example, in the case of 10 cents, the most significant byte of the counter would be set to binary 01010000, and the other 3 bytes to 0).

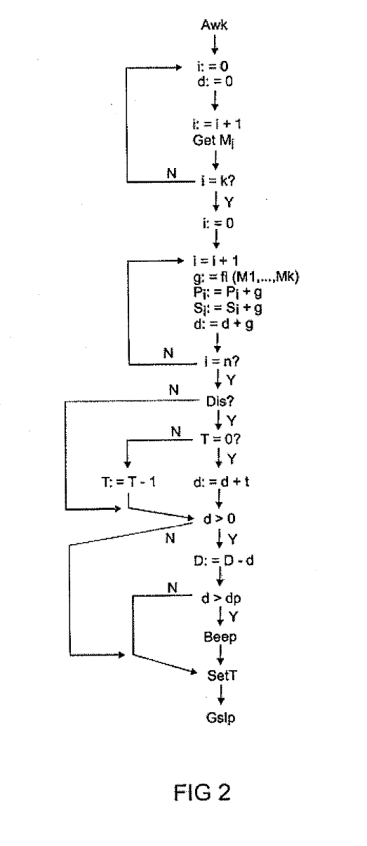

FIG. 2 shows the program process in the microcontroller with an implemented counter-memory functionality. In this case, the measured values M₁ to Mₖ are detected first. Then, n different mishandling situations are evaluated with the aid of the n weighting functions f₁ to fₙ, that is to say the weight g is in each case determined for each possible mishandling situation and, if the weight g is not 0, is increased corresponding to the associated primary and secondary counters. The n primary counters are annotated M₁ to Mₙ, and the n secondary counters are annotated S₁ to Sₙ. The change to the discount counter d is calculated in this process itself, and the discount counter D is then reduced if appropriate.

In one particularly simple situation, there are

a) one and only one mishandling situation (k=n) for each measurement variable
and
b) the weighting is 0 or 1 depending on whether the measured value is above or below a specific threshold (the functions fᵢ correspond to the step function sigma (Q₁−Mᵢ) with the threshold value of the respective Qᵢ for the respective variable i).

In order to avoid having to suddenly switch off the light on reaching the “rechargeable battery is empty”, this is already indicated to the user by slow blinking (of the rechargeable-battery empty LED) from a higher state of charge. If the rechargeable battery is now emptied further, this, in a further embodiment, could likewise have a negative effect on the discount. In this case, the user would be encouraged not to completely empty the rechargeable batteries, which would considerably lengthen the life in the case of lead-acid rechargeable batteries.

If “external charging” of the energy box is intended to be permitted, for example the charging of a small energy box in the form of a hand lamp by means of another large energy box, then both have the appropriate communication, but the energy box cannot be identified as a charger, which leads to a situation in which, although the hand lamp has been charged, however:

1. the primary counters are not reset, and
2. the discount for the hand lamp is reduced as the external charging increases (ampere hours). The latter could be reflected by a discount counter in the memory of the microcontroller.

### Data Communication

The minimum situation requires:

1. Simplex communication (unidirectional communication) from the charger to the energy box and
2. further Simplex communication from the energy box to the operator/vendor: The first communication could in the simplest case be provided by plugging in the charging cable, in which case the energy box identifies that the voltage has been applied for charging. Analogously, this will be done in the case of contactless inductive charging by the detection of a charging current in the energy box, caused by the inductive field of the charger. The energy box now sends the discount periodically for a period of, for example, 15 minutes in the form of blinking indications followed by a longer pause. The number of blinking pulses can be seen by the servicing personnel and by the customer. Although the customer business is handled during the 15 minutes, the charging process has, however, not yet been completed. The discount counter is therefore set to the maximum value again, and all the primary counters are set to zero, with the blinking furthermore being ceased.

If the voltage supply is interrupted before the 15 minutes have elapsed, the counters are not changed and the time measurement for the 15 minutes begins again from the start when next connected. This ensures that the discount data is not lost as a result of initial contact problems.

In this minimalistic situation, the primary and secondary counters and the stored history are not evaluated. These variants could ensure emergency operation, for example in the event of a failure of the communication electronics in the charger.

The full functionality described above is dependent, however, on Duplex communication (bidirectional communication) between the energy box and the charger. An appropriate communication protocol is used here for all appliances, for example in order to make it possible to use different chargers for the same energy box, or else to make it possible to distinguish between different energy boxes on the same charger, and to allow them to be operated.

Each energy box has a unique identification, as a result of which its data is not mixed with that from other energy boxes on the same charger. When a plurality of chargers are used these can be networked with one another and/or can interchange their data with a central database, for example via the Internet. By way of example, valid identities for energy boxes are stored in a central database. A plausibility check can also be carried out to determine whether the data that has been read can correspond (for example the secondary counts cannot decrease).

Conversely and alternatively, the energy box must identify the charger as a correct charger, by using a random number, which is produced in the energy box, to determine an appropriate response from the charger. More complex methods are possible, for example with a public and private key, as used, by way of example, for RFID identification.

In addition, individual user data can be transmitted by means of the communication from the charger to the energy box. For example, the dimming position in which he wishes to operate the light-emitting diodes in the case of an energy box that is combined to form a light. This allows the energy box to be designed more simply, since there is no need for the associated control element. The user could also program the energy box as a wake-up alarm: When renting out, the wake-up times for the coming week are stated at the cash desk, and the buzzer which is installed in the energy box starts to beep, with the light being switched on, at the said wake-up time. The communication between the energy box and the charger can take place in various ways:

1. Both data streams pass over the same path, for example via
a conductive connection/data lines
the conductive connection which is also used for energy transport (which in principle corresponds to PLC: power line communication). In this case, it should be noted that the required data rate for communication from the charger to the energy box may be considerably lower than that from the energy box to the charger. Full-duplex operation is therefore possible by separation in the frequency domain: a high-frequency signal flow from the energy box to the charger and a low-frequency signal (for example by switching the charging voltage on and off) from the charger to the energy box.

For the option illustrated in FIG. 3, of duplex communication, both the charger and the energy box have an information transmitter Tx and a receiver Rx. By way of example, the energy source for the charger may be solar cells, rechargeable batteries or a (public) alternating-current power supply system. Two possible situations are feasible:

1. The inductive connection is also used for inductive charging of the energy box, with the data being transmitted bidirectionally at the same time via the inductive coupling.
2. The two data streams (the data stream to the energy box and the data stream to the charger) take different paths. For example, the conductive connection which is used for transporting power can also be used for the data from the charger to the energy box. However, the return path is provided visually via the light-emitting diode, which is provided in the light in any case, for illumination (or an indicating light-emitting diode), whose light is received by a photo receiver in the charger. As an alternative to the conductive connection, the magnetic field of the inductive charging can also be appropriately modulated in amplitude and/or frequency, in order to transmit data from the charger to the energy box. In principle, many combinations are feasible, although, in particular, the embodiments illustrated in FIGS. 3 to 5 appear to be particularly advantageous.

In this case, as already mentioned above, the information flow from the charger to the energy box may take place by modulation of the magnetic field. However, in any case, there is an optical acknowledgement from the energy box to the charger (IR or visible light).

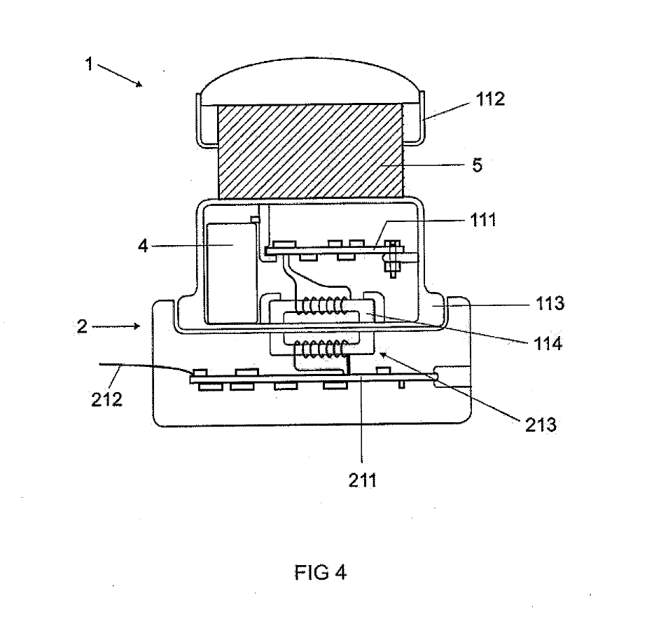

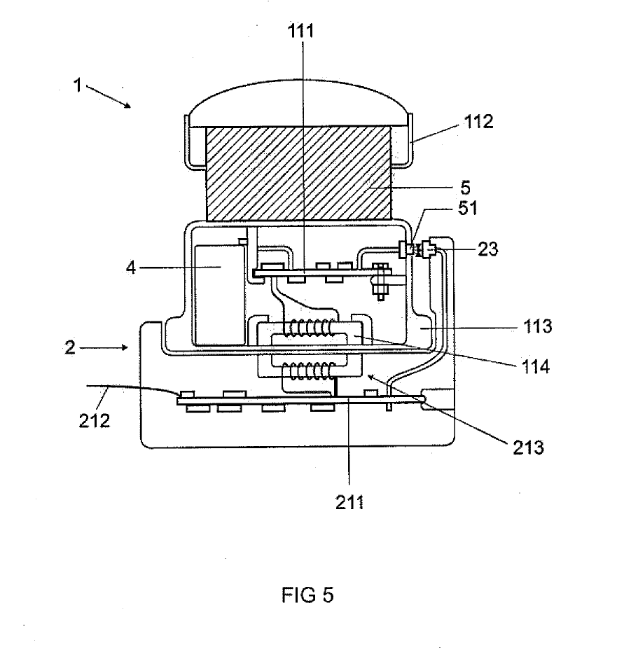

FIG. 4 shows one exemplary embodiment of a possible energy box 1 with the appropriate charger 2. The energy box 1 has a rechargeable battery 4, a lighting means 5 in a reflector, a printed circuit board 111 with the necessary circuit parts, and half of a magnetic core 114 for inductive energy transmission, with an appropriate winding. A locking tab 113 ensures that the energy box can be inserted into the charger 2 only in the correct position. The charger 2 likewise has a printed circuit board 211, on which the charging and communication electronics are accommodated. A power supply 212 in the form of a cable is connected to the printed circuit board 211. The charger 2 also has half of a magnetic core 213, which corresponds to the core 114 in the energy box 1.

FIG. 5 shows an energy box 1 with an integrated hand light and optical communication interface located in the charger. This uses the light-emitting diodes 51, which are provided in any case for indication of the operating state, for data transmission.

The use of optical data transmission at a high data rate allows all of the detected user data to be transmitted to the charging station during a fraction of the charging time.

However, as described above, the discount is additionally advantageously transmitted to the user by blinking characters by means of the light-emitting diode 51 (purpose: emergency operation should the data transmission not function and for simple monitoring of the data transmission). This blinking takes place during the pauses in the actual data transmission and whenever a specific number of data packets have been transmitted by the energy box.

In addition to the charging energy, information is also transmitted from the charger to the energy box via the magnetic field. In particular, the data comprises commands to the energy box to write data to the EEPROM in the energy box, or to cause the energy box to supply specific data from the EEPROM to the charger.

In contrast to data transmission from the energy box to the charger, a considerably lower data rate is sufficient for the communication direction from the charger to the energy box than for the optical return channel. Appropriate modulation of the magnetic field at a low data rate is adequate in this case. A low data rate in this data direction can be achieved both at the transmitter end and at the receiver end with relatively little effort and, furthermore, has only a minor influence on the efficiency of the charging system.

The magnetic field can be modulated in various ways: frequency and/or amplitude modulation rather than phase modulation appear to be particularly suitable, since phase modulation makes it considerably more difficult to design an energy-efficient charging device. Use of high Q-factor resonant circuits for the coupling networks and circuit topologies relieved of switching modes for the purpose of phase modulation is scarcely possible. In the simplest case, pure amplitude modulation is carried out by switching the magnetic alternating field (for example the half brige) on and off. A brief interruption in this case corresponds to a logic zero, and a long interruption to a logic one. The time periods between the interruptions define the word or packet end. A continuous alternating field means that no commands are being sent to the energy box, and it has only been charged.

As already mentioned above, when an energy box is placed in the charger, mutual identification takes place by means of a defined protocol. In this case, not only must the charger be authorized for the energy box, but also, conversely, the energy box must be authorized for the charger. Only when this process has been successfully completed does the charger continue to supply electrical energy via the magnetic alternating field, allowing the energy box to be charged. Depending on the useful data that is transmitted, the charging can be matched to the state of the energy box. For example, if the energy box has been stored for a long time in the discharged state before having been returned, then a servicing charge can be initiated in order to refresh the rechargeable battery, somewhat alleviating the loss of life suffered as a result of long storage in the deep-discharged state.

The neutral authorization process ensures that, on the one hand, the energy box cannot be externally charged and, on the other hand, that only registered energy boxes can be used on a charger (for example a plurality of operators of solar hubs operating the chargers 2, in one region).

There is not necessarily any need to transmit data via the magnetic field. A particularly simple system such as this without data transmission via the magnetic field could be chosen for cost reasons, and in order to reduce the complexity of the charging electronics. However, in a system such as this, the energy box has at least one detection circuit which changes to a special mode in the presence of an appropriate magnetic alternating field or a specific charging current, in which all of the data stored in the EEPROM is automatically sent to the charger. After the energy box does not receive an acknowledgement of correct reception from the charger, all the data is transmitted more repeatedly. In the simplest case, this continuous transmission of data takes place throughout the entire life or for at least x minutes after the start of charging. In order to allow rapid handling of the customer business, the data relating to the discount is transmitted first, followed by data relating to the user behavior during the previous rental time period, and finally all the other data. By way of example, the discount is transmitted 7 times successively. In this case, at least 5 of the received data records which describe the discount must be identical for these data records to be interpreted as being “correct”. If at least 5 identical data records have not been received, this is assessed as an indication that the data connection is poor (for example scattered light etc.). The charger, or the electronic cash point which is connected to the charger, will then signal to the operator/servicing personnel that the optical connection is poor. Another attempt must be made for data transmission by removing the energy box from the charger and inserting it again, as a result of which the microcontroller in the energy box once again detects inductive charging, and starts retransmission of the data in response to this.

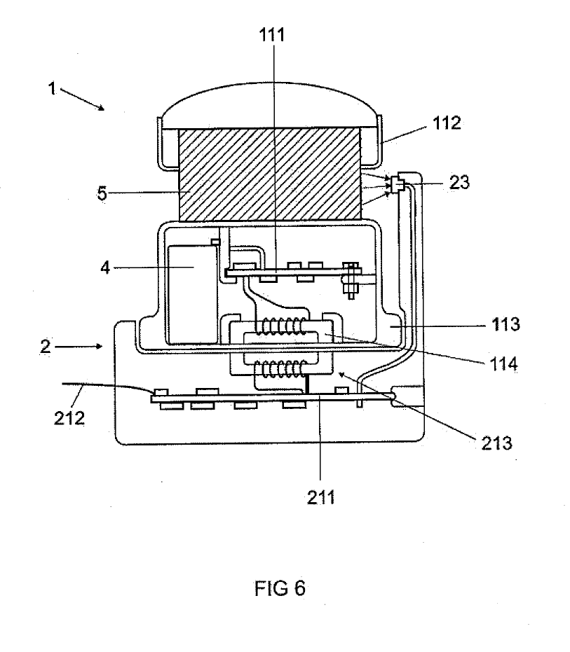

FIG. 6 shows an energy box which communicates with the charger optically and inductively. Data is transmitted optically from the energy box by lighting means and photo receivers (23). Data from the charger is transmitted inductively via the inductive charging device to the energy box. This embodiment is an alternative embodiment to the use of a monitoring light-emitting diode 51 as shown in FIG. 5. The modulation of the light flux from the main lighting means 5 allows data to be transmitted to the charger, which is equipped with appropriate photodetectors 23 for receiving data from the connected energy box. The modulated lighting means 5 is advantageously a light-emitting diode or a plurality of light-emitting diodes, since they allow a wide transmission bandwidth. The light-emitting diodes are operated by the microcontroller in the energy box.

1. An energy box comprising:
a rechargeable battery;
charging electronics having an information transmitter which is connected to the rechargeable battery;
an inductive charging device, which is connected to the charging electronics;
a controller having an information memory, which controller controls the charging electronics;
at least one sensor for detection of useful data, which sensor is coupled to the controller; and
at least one semiconductor light source, which is adapted for indication of data,
wherein the useful data which is stored in the controller is transmitted optically via the at least one semiconductor light source during the charging process.

2. The energy box as claimed in claim 1, wherein data can be transmitted via the inductive charging device.

3. The energy box as claimed in claim 1, wherein data can be transmitted inductively via the charging device and optically via the semiconductor light sources.

4. The energy box as claimed in claim 1, wherein the charging electronics are operated differently depending on the useful data.

5. The energy box as claimed in claim 1, wherein the energy box contains a lighting means, which can be switched on and off for illumination purposes.

6. The energy box as claimed in claim 1, wherein the lighting means uses a semiconductor light source.

7. The energy box as claimed in claim 1, wherein the lighting means is identical to the semiconductor light source which is used both for indication of data and for transmission of the useful data.

8. A method for charging an energy box as claimed in claim 1, comprising the steps of:
authorization of the energy box and of a charger which charges the energy box;
transmission of useful data, which is stored in the energy box, to the charger; and
setting of charging parameters on the basis of the transmitted useful data.

9. The method as claimed in claim 8, wherein the charging parameters and/or other data are/is transmitted from the charger to the energy box.

10. The method as claimed in claim 8, wherein the data is transmitted optically.

11. The method as claimed in claim 8, wherein the data is transmitted inductively.

12. The method as claimed in claim 8, wherein the data is transmitted optically and inductively.
